(19) United States
(12) Patent Application Publication
(10) Pub. No.: US 2022/0391689 A1
(43) Pub. Date: Dec. 8, 2022

(54) LOGIC-BASED NEURAL NETWORKS

(71) Applicant: VIANAI SYSTEMS, INC., Palo Alto, CA (US)

(72) Inventor: Vishal Inder SIKKA, Los Altos Hills, CA (US)

(21) Appl. No.: 17/339,591

(22) Filed: Jun. 4, 2021

(51) Int. Cl. G06N 3/08; G06K 9/62

(52) U.S. Cl. CPC G06N 3/08; G06K 9/626; G06K 9/6262

(57) ABSTRACT

Various embodiments set forth systems and techniques for augmenting neural networks. The techniques include causing one or more neural networks to generate first output based on a first input; identifying one or more rules associated with the first input; processing the first output based on the one or more rules to generate a second output; and transmitting the second output, instead of the first output, as a result of processing the first input.

### BACKGROUND

### Field of the Various Embodiments

The various embodiments relate generally to computer science and artificial intelligence, and more specifically, to techniques for logic-based neural networks.

### Description of the Related Art

In a conventional neural network design process, a designer writes program code to develop a neural network architecture that addresses a particular type of problem. The designer trains the neural network using training data in conjunction with target outputs that the neural network should produce when processing that training data. During the training process, a training algorithm updates weights included in the layers of the neural network to improve the degree to which the neural network generates outputs that are consistent with the target outputs. Once training is complete, the neural network is tested using validation data to determine the accuracy with which the neural network can generate target outputs associated with the validation data.

After training, the neural network can process input similar to the training data and generate output based on the input. For example, a neural network may be trained to receive pictures of street signs and generate output indicating whether the street sign is a stop sign. The accuracy of the neural network, however, depends on the training data used to train the neural network. If the neural network is provided input that is significantly different from the training data, then the neural network may not be able to provide accurate output. Referring to the above example, if the neural network receives a picture of a stop sign that does not look like a typical stop sign, then the output generated by the neural network may indicate that the sign is not a stop sign. Even if the neural network is retrained and subsequently operates with higher accuracy, the neural network will still encounter inputs where the neural network does not produce the correct result.

Another drawback of a neural network is that the neural network processes the input in insolation, without additional context or data. The neural network is unable to utilize contextual or external data when processing the input. If the neural network is provided input that, given its context should produce a different result than expected, then the neural network may also not be able to provide accurate output. Referring to the above example, if the neural network receives a picture of a building whose sign looks similar to a stop sign, then the output generated by the neural network may indicate that the sign is a stop sign. However, given the context of the picture, e.g. the sign being located on a building, the output would be incorrect.

Additionally, output generated by the neural network does not include any context or explanations that can be used to guide decisions or analysis. Referring to the above examples, the neural network only generates output indicating whether a sign is a stop sign, without providing any indication as to why or how the neural network made the determination.

As the foregoing illustrates, what is needed in the art are more effective techniques for regulating the operation of neural networks.

### SUMMARY

One embodiment of the present application sets forth a computer-implemented method for augmenting neural networks. The method includes causing one or more neural networks to generate first output based on a first input; identifying one or more rules associated with the first input; processing the first output based on the one or more rules to generate a second output; and transmitting the second output, instead of the first output, as a result of processing the first input.

At least one technical advantage of the disclosed techniques relative to the prior art is that the disclosed AI model interprets and enhances output generated by neural networks using external data and rules, thereby generating results that are more accurate compared to prior approaches. Additionally, the AI model can include contextual and/or analytical information in the generated results. The contextual and/or analytical information enable users to articulate and explain the results provided by the AI model and how the AI model arrived at those results.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments.

FIG. 2 is a more detailed illustration of the artificial intelligence (AI) model of FIG. 1, according to various embodiments.

FIG. 3 is an illustration of output generation using the rules engine of FIG. 2, according to various embodiments.

FIG. 4 is an illustration of output generation using the rules engine of FIG. 2, according to various embodiments.

FIG. 5 is a flowchart of method steps for generating output using a rules engine, performed by the AI model of FIG. 1, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

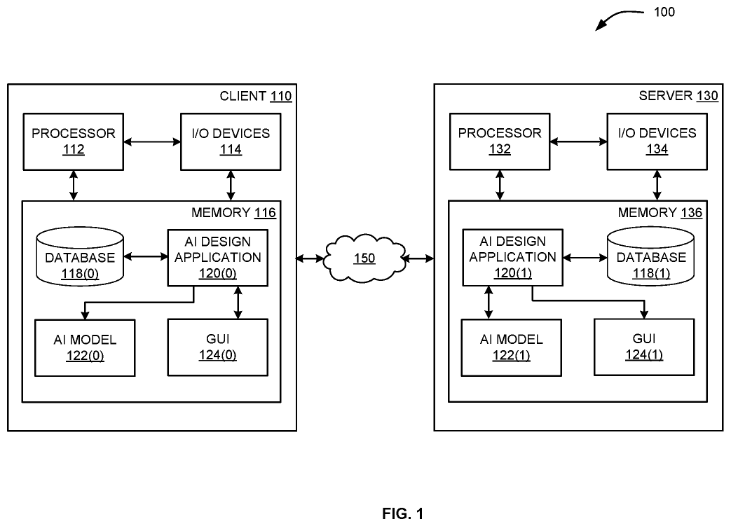

FIG. 1 illustrates a system configured to implement one or more aspects of the various embodiments. As shown, system 100 includes client 110 and server 130 coupled together via network 150. Client 110 or server 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others. Client 110 and server 130 are configured to communicate via network 150.

As further shown, client 110 includes a processor 112, input/output (I/O) devices 114, and a memory 116, coupled together. Processor 112 includes any technically feasible set of hardware units configured to process data and execute software applications. For example, processor 112 could include one or more central processing units (CPUs), one or more graphics processing units (CPUs), and/or one or more parallel processing units (PPUs). I/O devices 114 include any technically feasible set of devices configured to perform input and/or output operations, including, for example, a display device, a keyboard, and a touchscreen, among others.

Memory 116 includes any technically feasible storage media configured to store data and software applications, such as, for example, a hard disk, a random-access memory (RAM) module, and a read-only memory (ROM). Memory 116 includes a database 118(0), an artificial intelligence (AI) design application 120(0), an AI model 122(0), and a graphical user interface (GUI) 124(0). Database 118(0) is a file system and/or data storage application that stores various types of data. AI design application 120(0) is a software application that, when executed by processor 112, interoperates with a corresponding software application executing on server 130 to generate, analyze, evaluate, and describe one or more AI models. AI model 122(0) includes one or more artificial neural networks configured to perform general-purpose or specialized artificial intelligence-oriented operations. GUI 124(0) allows a user to interact with AI design application 120(0).

Server 130 includes a processor 132, I/O devices 134, and a memory 136, coupled together. Processor 132 includes any technically feasible set of hardware units configured to process data and execute software applications, such as one or more CPUs, one or more GPUs, and/or one or more PPUs. I/O devices 134 include any technically feasible set of devices configured to perform input and/or output operations, such as a display device, a keyboard, or a touchscreen, among others.

Memory 136 includes any technically feasible storage media configured to store data and software applications, such as, for example, a hard disk, a RAM module, and a ROM. Memory 136 includes a database 118(1), an AI design application 120(1), an AI model 122(1), and a GUI 124(1). Database 118(1) is a file system and/or data storage application that stores various types of data, similar to database 118(0). AI design application 120(1) is a software application that, when executed by processor 132, interoperates with AI design application 120(0) to generate, analyze, evaluate, and describe one or more AI models. AI model 122(1) includes one or more artificial neural networks configured to perform general-purpose or specialized artificial intelligence-oriented operations. GUI 124(1) allows a user to interface with AI design application 120(1).

As a general matter, databases 118(0) and 118(1) represent separate portions of a distributed storage entity. Thus, for simplicity, databases 118(0) and 118(1) are collectively referred to herein as database 118. Similarly, AI design applications 120(0) and 120(1) represent separate portions of a distributed software entity that is configured to perform any and all of the inventive operations described herein. As such, AI design applications 120(0) and 120(1) are collectively referred to hereinafter as AI design application 120. AI models 122(0) and 122(1) likewise represent a distributed AI model that includes one or more neural networks. Accordingly, AI models 122(0) and 122(1) are collectively referred to hereinafter as AI model 122. GUIs 124(0) and 124(1) similarly represent distributed portions of one or more GUIs. GUIs 124(0) and 124(1) are collectively referred to herein as GUI 124.

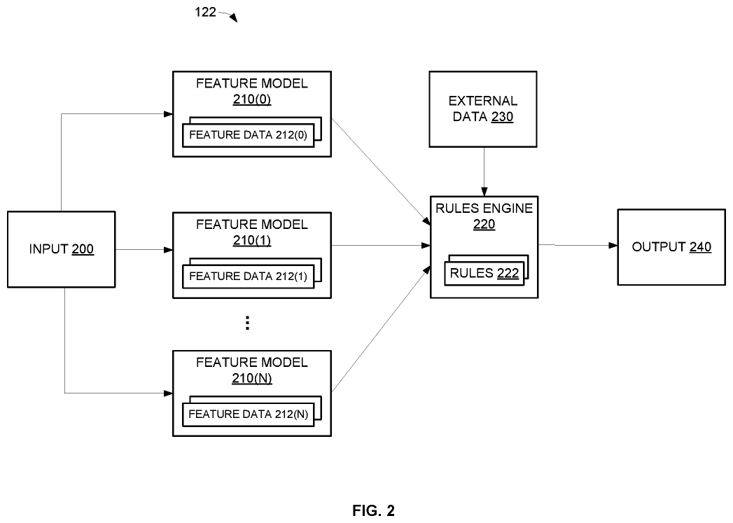

In operation, AI design application 120 generates AI model 122 based on user input that is received via GUI 124. GUI 124 exposes design and analysis tools that allow the user to create and edit AI model 122, explore the functionality of AI model 122, evaluate AI model 122 relative to training data, and generate various data describing and/or constraining the performance and/or operation of AI model 122, among other operations. AI model 122 is described in greater detail below in conjunction with FIG. 2.

FIG. 2 is a more detailed illustration of the artificial intelligence (AI) model of FIG. 1, according to various embodiments. As shown, AI model 122 is a hierarchical system of interconnected modules, such as the feature models 210 and the rules engine 330, that are configured to interoperate with one another to process input 200 and generate output 240.

Input 200 generally includes any technically feasible type of data, including audio data, video data, image data, text data, raw and/or processed sensor data, any combination of such data, and so forth. Output 240 generally includes at least one of a classification associated with input 200 or a set of natural language expressions that describes one or more evaluations or analysis performed by AI model 122 when processing input 200.

AI model 122 includes feature models 210(0) through 210(N) and rules engine 220, where N is an integer value. Feature models 210(0) through 210(N) are coupled to the rules engine 220. Feature models 210(0) through 210(N) are configured to process input 200 to generate feature data 212(0) through 212(N), respectively.

A given feature model 210 is a neural network that implements one or more feature detection algorithms to quantify the presence of one or more features within input 200 and to generate feature data 212 to represent the detected features. A given feature model 210 may be configured to identify low-level features, such as basic geometric shapes, short sequences of audio samples, simple data patterns, and other features associated with various data types. Alternatively, a given feature model 210 may be configured to identify high-level features, such as real-world objects, spoken words, complex patterns of data, and other features associated with various data types. In various embodiments, a given feature model 210 may be a binary convolutional neural network (CNN), a feature map, a classifier, or any other technically feasible type of AI algorithm or neural network algorithm capable of detecting features. Corresponding feature data 212 for a given feature model 210 may be, for example, a value representing the likelihood that the corresponding feature is in input 200, a label identifying a detected feature, data identifying location(s) of the corresponding feature within input 200, and such.

Rules engine 220 is configured to process feature data 212(0) through 212(N) based on rules 222 to generate output 240. Additionally, rules engine 220 may evaluate feature data 212(0) through 212(N) in conjunction with external data 230. External data 230 generally includes any technically feasible type of data, including text data, sensor data, location data, database data, any combination of such data, and so forth, that is received or retrieved from a data source external to AI model 122. As referred to herein, external data 230 refers to any data that does not comprise feature data 212 received from feature models 210. For example, external data 230 may be retrieved from database 118, provided by a user via GUI 124, or received from another server or other computing device (not shown).

A given rule 222 comprises a set of one or more expressions and/or statements that evaluate, combine, analyze, augment, or otherwise processes one or more input parameters to produce a corresponding output 240 for the given rule 222. For example, a given rule 222 may include expressions and/or statements that combine the values of two or more input parameters; compare the values of two or more input parameters; weigh one or more input parameters; perform one or more actions based on the value of one or more input parameters; and such. The input parameters for a given rule 222 may correspond to one or more sets of feature data 212 and/or one or more pieces of external data 230.

In some embodiments, evaluating a given rule 222 includes passing the values of feature data 212 and/or external data 230 to the input parameters of the given rule 222. In some embodiments, rules engine 220 may determine which feature data 212 and/or external data 230 corresponds to which input parameters of the given rule 222 based on a mapping that maps feature data 212 and/or external data 230 to input parameters. In some embodiments, each rule 222 is associated with a respective mapping. In some embodiments, a mapping is associated with a plurality of rules 222 in rules engine 220.

Rules engine 220 evaluates one or more expressions of the given rule 222 and/or executes one or more statements of the given rule 222 to generate corresponding output 240. In some embodiments, rules engine 220 determines that one or more particular input parameters of the given rule 222 corresponds to one or more pieces of external data. Rules engine 220 may retrieve or request the one or more pieces of external data, and pass the one or more pieces of external data to the one or more particular input parameters.

The corresponding output 240 for a given rule 222 generally comprises any type of output data associated with input 200 or a feature of input 200. For example, output 240 may comprise one or more of a classification associated with input 200, a classification associated with a feature of input 200, a value associated with input 200, a value associated with a feature of input 200. Additionally, the corresponding output 240 may include additional data associated with input 200 or a feature of input 200, for example, feature data 212 or external data 230 provided as input parameters to the given rule 222 or data generated based on the input parameters of the given rule 222. Additionally, the corresponding output 240 may include natural language expressions that describe results associated with the one or more expressions and/or statements of the given rule 222 and/or the input parameters provided to the given rule 222. For example, output 240 may comprise natural language expressions describing the results from combining input values; the results from comparing input values; the value(s) of one or more input parameters and/or the corresponding action(s) performed based on the value(s); the weights applied to the input parameters; the values of feature data 212 and/or external data 230; and such.

In some embodiments, a given expression or statement of a rule 222 includes instructions to generate a corresponding natural language expression. When the given expression or statement is evaluated or executed by rules engine 220, the instructions cause rules engine 220 to generate the corresponding natural language expression. As an example, rules engine 220 may evaluate an expression and, in response, generate a natural language expression describing the expression and an indication of the results of evaluating the expression.

In some embodiments, the output 240 is displayed to a user, for example, via GUI 124. In some embodiments, the output 240 is stored in memory for subsequent use, for example, as input for other feature models, other rules engines, or other AI models.

As an example, a rule 222 may receive input comprising feature data that indicates a shape of a sign, a color of the sign, and text depicted on the sign. Evaluating the rule 222 includes evaluating the shape, color, and text to generate a result indicating whether the sign is likely a stop sign. Additionally, the result may include natural language expressions indicating the shape, color, and text that were evaluated to generate the result. The result may be provided to a user via GUI 124.

In some embodiments, rules 222 are defined using a rule-definition language, such as a scripting language, programming language, and such. Each rule 222 may comprise a set of instructions written in the rule-definition language. For example, each expression and/or statement of a rule 222 may be written using the rule-definition language. Rule engine 220 may be configured to interpret and execute the set of instructions to evaluate the rule 222.

As discussed above, AI design application 120 generates AI model 122 based on user input that is received via GUI 124. In some embodiments, GUI 124 includes user interface elements for adding, modifying, removing, and/or viewing rules 222. In response to user interactions with the user interface elements of GUI 124, AI design application 120 may add a new rule 222, modify an existing rule 222, remove an existing rule 222, and/or display a graphical representation of the expressions and statements of a rule 222.

In various embodiments, GUI 124 includes user interface elements that allow a user to specify a new rule 222, including defining one or more parameters for the new rule 222 and one or more expressions and/or statements for the new rule 222. Additionally, GUI 124 may include user interface elements that allow a user to select one or more feature models 210 and map feature data from the one or more feature models 210 to one or more input parameters of the new rule 222. Additionally, GUI 124 may include user interface elements that allow a user to select or define one or more external data sources and map pieces of external data from the one or more external data sources to one or more input parameters of the new rule 222. In response to the user specifying the new rule 222, AI design application 120 generates the new rule 222 with the corresponding input parameters and corresponding expressions and/or statements. In some embodiments, the user uses a rule-definition language to define the new rule 222. In some embodiments, AI design application 120 generates rule-definition language corresponding to the expressions and statements specified by the user input.

In some embodiments, rules 222 are configured to evaluate feature data 212 and/or external data 230 corresponding to a particular type of input 200. Each rule may output a result related to a particular feature, classification, or other data related to input 200.

In some embodiments, rules 222 include rules corresponding to any number of types of input 200. Rules engine 220 may select one or more rules to evaluate based on the type of input 200. As an example, one or more particular rules of rules 222 may correspond to a particular type of input. Rules engine 220 may determine that an input 200 is the particular type of input, and select the one or more particular rules to evaluate.

In some embodiments, each rule 222 specifies a respective set of input parameters. Rules engine 220 may select one or more rules to evaluate based on the feature data 212 received by rules engine 220 from the feature models 210. For example, rules engine 220 may determine, for each rule 222, whether each input parameter corresponds to feature data 212 received by rules engine 220, to external data 230, or to feature data that has not been received by rules engine 220. If every input parameter of a rule 222 can be provided using either the received feature data 212 or by external data 230, then rules engine 220 determines that the rule 222 can be evaluated and selects the rule 222.

In some embodiments, a user selects one or more rules 222 for rules engine 220 to evaluate, for example, via GUI 124. Additionally, a user may select one or more feature models 210 for providing feature data 212 to rules engine 220.

In some embodiments, rules engine 220 determines one or more input parameters needed for evaluating a given rule 222. Rules engine receives or requests feature data 212 from feature models 210 and/or data from external data 230.

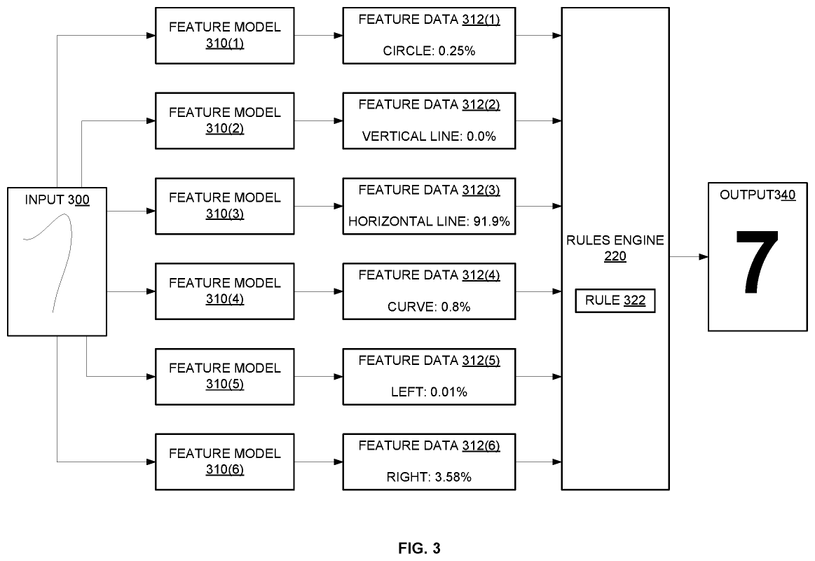

FIG. 3 is an illustration of output generation using rules engine 220, according to various embodiments. In FIG. 3, input 300 illustrates an example input received by AI model 120. In the example shown, input 300 is an image of a handwritten “7.” Input 300 may be received via a user interface element of GUI 124. The user interface element of GUI 124 may be configured to receive any technically feasible type of input, including audio data, video data, image data, and other types of data discussed above in conjunction with FIG. 2.

The input 300 is provided to each of feature models 310(1)-310(6). Each feature model 310(1)-310(6) implements a respective feature detection algorithm to quantify the presence of a respective feature within input 300. In the example shown, feature model 310(1) is configured to detect the presence of a circle in input 300; feature model 310(2) is configured to detect the presence of a vertical line in input 300; feature model 310(3) is configured to detect the presence of a horizontal line in input 300; feature model 310(4) is configured to detect the presence of a curve in input 300; feature model 310(5) is configured to detect the presence of a left-leaning diagonal line in input 300; and feature model 310(6) is configured to detect the presence of a right-leaning diagonal line in input 300.

Each feature model 310(1)-310(6) generates corresponding feature data 312(1)-312(6), respectively, to represent the detected feature. In the example shown, feature data 312(1) indicates a 0.25% likelihood that a circle is in input 300; feature data 312(2) indicates a 0.0% likelihood a vertical line is in input 300; feature data 312(3) indicates a 91.9% likelihood that a horizontal line is in input 300; feature data 312(4) indicates a 0.8% likelihood that a curve is in input 300; feature data 312(5) indicates a 0.01% likelihood that a left-facing diagonal is in input 300; and feature data 312(6) indicates a 3.58% likelihood that a right-facing diagonal is in input 300.

Feature data 312(1)-312(6) are provided to rules engine 220. As shown, rules engine 220 includes a rule 322. Rules engine 220 evaluates rule 322 based on feature data 312(1)-312(6). Rule 322 may specify a set of input parameters. The input parameters of rule 322 may correspond to feature data 312(1)-312(6). For example, rule 322 may include input parameters “circle,” “vert,” “horiz,” “curve,” “left,” and “right,” corresponding to feature data 312(1)-312(6), respectively.

Rule 322 further specifies one or more expressions and/or statements that evaluate, combine, analyze, augment, or otherwise processes the input parameters to produce an output 340. As an example, when evaluated by rules engine 220, rule 322 may determine which number input 300 is based on the features identified in input 300. Rule 322 may include expressions that, for each input parameter, assign a true/false value to a corresponding variable based on whether the value of the input parameter exceeds a threshold amount. For example, rule 322 may include an expression that determines if the value of the “vert” parameter is greater than 40%. If the value is greater than 40% then a value of “true” may be assigned to a “vertical” variable, and if the value is less than 40% then a value of “false” may be assigned to the “vertical” variable. Rule 322 may include similar expressions for each input variable. Rule 322 may further include expressions that determine an output number based on which variables are true and which variables are false. For example, rule 322 may include an expression that determines if the variable “circle” is true but the variables “vertical,” “horizontal,” “curve,” “left,” and “right” are false, and if so, causes an output of “0” to be generated. Rule 322 may include another expression that determines if the variable “vertical” is true but the variables “circle,” “horizontal,” “curve,” “left,” and “right” are false, and if so, causes an output of “1” to be generated.

Rules engine 220 evaluates rule 322 based on feature data 312(1)-312(6) to generate output 340. In the example shown, output 340 is a “7,” indicating that rules engine 220 has determined, based on feature data 312(1)-312(6), that input 300 is a “7.” In some embodiments, rule 322 is defined using a rule-definition language. Evaluating rule 322 may include, using rules engine 220, interpreting expressions and/or statements written using the rule-definition language and executing the expressions and/or statements.

In some embodiments, output 340 may also include natural language expressions that describe results associated with the expressions, statements, and/or input parameters of rule 322. For example, output 340 may indicate the Boolean value of each variable and indicate that the combination of values resulted in the determination that input 300 is a “7.”

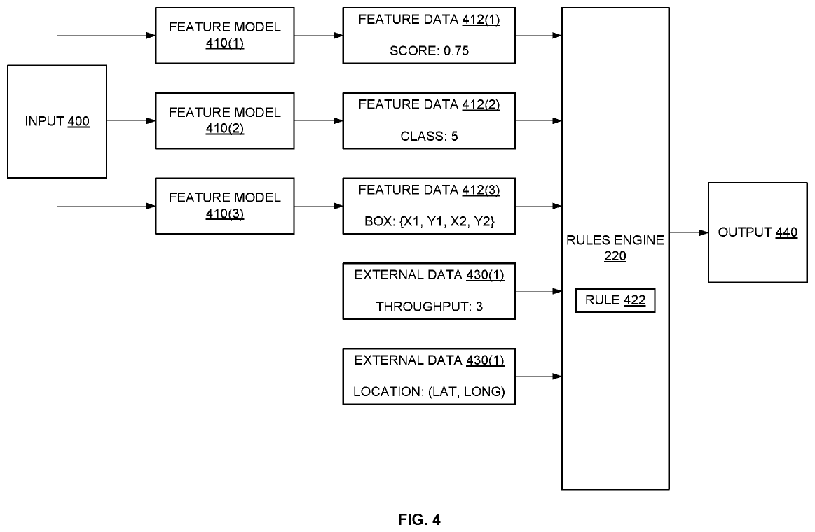

FIG. 4 is another illustration of output generation using rules engine 220, according to various embodiments. In FIG. 4, input 400 illustrates an example input received by AI model 120. Input 400 may be received via a user interface element of GUI 124. The user interface element of GUI 124 may be configured to receive any technically feasible type of input, including audio data, video data, image data, and other types of data discussed above in conjunction with FIG. 2.

The input 400 is provided to each of figure models 410(1)-410(3). Each feature model 410(1)-410(3) implements a respective feature detection algorithm to quantify the presence of a respective feature within input 400. Assume input 400 comprises an image of a road. In the example shown, feature model 410(1) is configured to detect the presence of road damage of the road in input 400; feature model 410(2) is configured to detect a class of the road damage in input 400; and feature model 410(3) is configured to determine a location of the road damage within input 400.

Each feature model 410(1)-410(3) generates corresponding feature data 412(1)-412(3), respectively, to represent the detected feature. In the example shown, feature data 412(1) indicates a score of 0.75 corresponding to road damage of the road in input 400; feature data 412(2) indicates a class of 5 corresponding to the road damage in input 400; and feature data 412(3) indicates that the road damage in input 400 is located within a box with corner coordinates (X1, Y1) and (X2, Y2).

Feature data 412(1)-412(3) are provided to rules engine 220. As shown, rules engine 220 includes a rule 422. Rules engine 220 evaluates rule 422 based on feature data 412(1)-412(3). Rule 422 may specify a set of input parameters. The input parameters of rule 422 may correspond to feature data 412(1)-412(3). For example, rule 422 may include input parameters “score,” “class,” and “box,” corresponding to feature data 412(1)-412(3), respectively. Rule 422 may also include input parameters corresponding to external data. Rules engine 220 receives or requests the external data from one or more data sources other than the feature models 410 based on the input parameters of rule 422. As shown, rules engine 220 receives external data 430(1) and 430(2). External data 430(1) indicates that the road depicted in input 400 has a throughput of 3, and external data 430(2) indicates latitude and longitude coordinates of the road in input 400. Rule 422 may further include input parameters “throughput” and “location” corresponding to external data 430(1) and 430(2), respectively.

Rule 422 further specifies one or more expressions and/or statements that evaluate, combine, analyze, augment, or otherwise processes the input parameters to produce an output 440. As an example, when evaluated by rules engine 220, rule 422 may determine a repair priority for the road damage in input 400 based on the class, score, and throughput of the road. Rule 422 may include expressions that determine whether the road in input 400 is a major artery or a local road based on the value of the “throughput” parameter and assign a corresponding value to a “function” variable. Rule 422 may further include expressions that determine a priority value based on the value of the “score” parameter, the value of the “class” parameter, and the value assigned to the “function” variable, and causes an output corresponding to the priority value to be generated.

Rules engine 220 evaluates rule 422 based on feature data 412(1)-412(3) and external data 430(1)-430(2) to generate output 440. For example, output 440 may be “HIGH PRIORITY,” indicating that rules engine 220 has determined, based on feature data 412(1)-412(3) and external data 430(1)-430(2), that input 400 depicts road damage with a high repair priority. In some embodiments, rule 422 is defined using a rule-definition language. Evaluating rule 422 may include, using rules engine 220, interpreting expressions and/or statements written using the rule-definition language and executing the expressions and/or statements.

In some embodiments, output 440 may also include a visual indication of the road damage in input 400. For example, rule 422 may include a statement that, when executed, causes rules engine 220 to generate an image comprising input 400 and a box based on the coordinates specified in the “box” input parameter.

In some embodiments, output 440 may also include natural language expressions that describe results associated with the expressions, statements, and/or input parameters of rule 422. For example, output 440 may indicate the location of the road. As another example, output 440 may indicate that the repair priority was determined based on the score of the road damage, the class of the road damage, and whether the road is a major artery, and indicate the respective values for each factor.

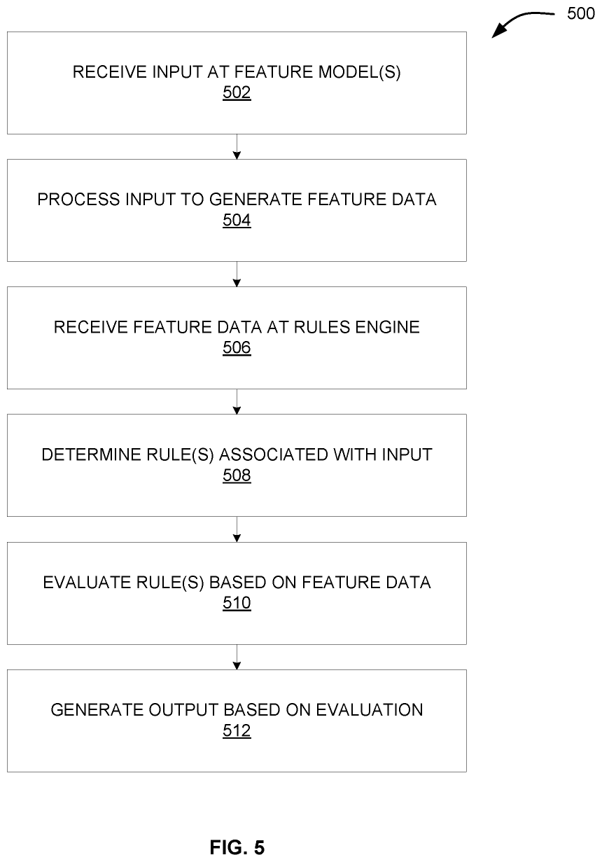

FIG. 5 is a flow diagram of method steps for generating output using the AI model 122 of FIG. 1, according to various embodiments. Although the method steps are described in conjunction with the systems of FIGS. 1 and 2, persons skilled in the art will understand that any system configured to perform the method steps in any order falls within the scope of the present disclosure.

As shown, a method 500 begins at step 502, where AI model 122 receives an input 200 at one or more feature models 210. In some embodiments, input 200 is provided to each feature model 210 included in AI model 122. In some embodiments, AI model 122 selects one or more particular feature models 210 of a plurality of feature models 210. For example, one or more particular feature models 210 of a plurality of feature models 210 may be configured to process input 200. AI model 122 may determine the one or more particular feature models 210 based on input 200 and provide input 200 to the one or more particular feature models. As another example, a user may select one or more rules 222, for example, via GUI 124. AI model 122 determines one or more feature models corresponding to the input parameters of the one or more selected rules 222.

In some embodiments, a user selects one or more feature models to use for processing input 200, for example, via GUI 124. Input 200 is provided to the one or more selected feature models.

At step 504, AI model 122 causes each of the one or more feature models 210 to process input 200 and generate respective feature data 212. A given feature model 210 is generally a neural network that implements one or more feature detection algorithms to quantify the presence of one or more features within the input and to represent the detected features via feature data 212. A given feature model 210 may be configured to identify low-level features, such as basic geometric shapes, short sequences of audio samples, simple data patterns, and other features associated with various data types. Alternatively, a given feature model 210 may be configured to identify high-level features, such as real-world objects, spoken words, complex patterns of data, and other features associated with various data types. Feature models 210 may perform convolution operations, aggregation operations, threshold comparison operations, and other types of operations commonly associated with neural networks and/or deep neural networks. Corresponding feature data 212 for a given feature model 210 may be, for example, a value representing the likelihood that the corresponding feature is in input 200, a label identifying a detected feature, data identifying location(s) of the corresponding feature within input 200, and such.

At step 506, rules engine 220 receives feature data 212 from the one or more feature models 210.

At step 508, rules engine 220 determines one or more rules 222 associated with input 200. Determining the one or more rules associated with input 200 is performed in a manner similar to that disclosed above with respect to rules engine 220.

In some embodiments, AI model 120 is configured to process any number of types of input data. Rules 222 may include rules corresponding to different types of input. Rules engine 220 may determine an input type of input 200 and select one or more particular rules 222 corresponding to the input type of input 200. In some embodiments, AI model 120 is configured to process a single type of input. Each rule 222 of rules engine 220 may be a rule that is associated with input 200.

In some embodiments, rules engine 220 selects one or more particular rules 222 based on the input parameters of the rules 222 and the received feature data 212. For example, rules engine 220 may determine, for each rule 222, whether each input parameter corresponds to feature data 212 received by rules engine 220, to external data 230, or to feature data that has not been received by rules engine 220. If every input parameter of a rule 222 can be provided using either the received feature data 212 or by external data 230, then rules engine 220 determines that the rule 222 can be evaluated and selects the rule 222.

In some embodiments, rules engine 220 selects the one or more rules 222 based on user input. For example, GUI 124 may include one or more user interface elements for displaying and selecting rules 222. A user may select one or more rules 222 for rules engine 220 to evaluate using the one or more user interface elements of GUI 124.

At step 510, rules engine 220 evaluates the one or more rules 222 based on the feature data 212. Evaluating the one or more rules 222 is performed in a manner similar to that disclosed above with respect to rules engine 220.

In some embodiments, evaluating a given rule 222 includes passing the values of feature data 212 and/or external data 230 to the input parameters of the given rule 222. Rules engine 220 evaluates one or more expressions of the given rule 222 and/or executes one or more statements of the given rule 222 to generate corresponding output 240.

In some embodiments, rules engine 220 determines that one or more particular input parameters of the given rule 222 corresponds to one or more pieces of external data. Rules engine 220 may retrieve or request the one or more pieces of external data, and pass the one or more pieces of external data to the one or more particular input parameters.

In some embodiments, rules 222 are defined using a rule-definition language, such as a scripting language, programming language, and such. Rule engine 220 may be configured to interpret and execute expressions and statements written in the rule-definition language in order to evaluate the rules 222.

At step 512, rules engine 220 generates output 240 based on evaluating the one or more rules 222. Generating output 240 is performed in a manner similar to that disclosed above with respect to rules engine 220. The corresponding output 240 for a given rule 222 generally comprises any type of output data associated with input 200 or a feature of input 200. Additionally, the corresponding output 240 may include natural language expressions that describe results associated with the one or more expressions and/or statements of the given rule 222 and/or the input parameters provided to the given rule 222.

In some embodiments, a given expression or statement of a rule 222 includes instructions to generate a corresponding natural language expression. When the given expression or statement is evaluated or executed by rules engine 220, the instructions cause rules engine 220 to generate the corresponding natural language expression.

Output 240 may be transmitted, displayed, stored, or otherwise provided as a result produced by AI model 122 processing input 200. In some embodiments, output 240 is provided as a result produced by AI model 122 in conjunction with other output generated by elements of AI model 122, such as feature data 212 generated by feature models 210. In some embodiments, output 240 is provided as a result produced by AI model 122 instead of output generated by the feature models 210.

In some embodiments, the output 240 is displayed to a user, for example, via GUI 124. In some embodiments, the output 240 is stored in memory for subsequent use, for example, as input for other feature models, other rules engines, or other AI models or by other applications.

In sum, an artificial intelligence (AI) model includes one or more neural networks coupled to a rules engine. The one or more neural networks are configured to process an initial input to detect different features within the initial input and generate corresponding output. The AI model provides the output generated by the one or more neural networks to the rules engine as input. The rules engine is configured to receive the output generated by the one or more neural networks and evaluate one or more rules, based on the output generated by the one or more neural networks, to generate an output associated with the initial input. The rules engine may also generate output associated with evaluation of the one or more rules.

At least one technical advantage of the disclosed techniques relative to the prior art is that the disclosed AI model interprets and enhances output generated by neural networks using external data and rules, thereby generating results that are more accurate compared to prior approaches. Additionally, the AI model can include contextual and/or analytical information in the generated results. The contextual and/or analytical information enable users to articulate and explain the results provided by the AI model and how the AI model arrived at those results.

1. In some embodiments, a computer-implemented method for processing inputs using neural networks comprises causing one or more neural networks to generate a first output based on a first input; identifying one or more rules associated with the first input; processing the first output based on the one or more rules to generate a second output; and transmitting the second output, instead of the first output, as a result of processing the first input.

2. The method of clause 1, further comprising identifying one or more pieces of external data associated with the first input; wherein processing the first output based on the one or more rules is further based on the one or more pieces of external data.

3. The method of any of clauses 1-2, wherein each rule of the one or more rules comprises one or more respective expressions, wherein processing the first output based on the one or more rules comprises, for each rule, evaluating each expression of the one or more respective expressions.

4. The method of any of clauses 1-3, wherein each rule of the one or more rules comprises one or more respective statements, wherein processing the first output based on the one or more rules comprises, for each rule, executing each statement of the one or more respective statements.

5. The method of any of clauses 1-4, wherein each rule of the one or more rules specifies one or more respective input parameters, wherein processing the first output based on the one or more rules comprises, for each rule determining one or more portions of the first output that correspond to the one or more respective input parameters; providing the one or more portions of the first output as input to the rule; and evaluating the rule based on the one or more portions of the first output.

6. The method of any of clauses 1-5, wherein processing the first output based on the one or more rules further comprises, for each rule determining one or more pieces of external data correspond to the one or more respective input parameters; requesting the one or more pieces of external data from one or more external data sources; providing the one or more pieces of external data as input to the rule; wherein evaluating the rule is further based on the one or more pieces of external data.

7. The method of any of clauses 1-6, wherein generating the second output includes generating a natural language expression that indicates to a user one or more results of evaluating the one or more rules.

8. The method of any of clauses 1-7, wherein generating the second output includes generating a natural language expression that indicates to a user one or more characteristics of the first output.

9. The method of any of clauses 1-8, wherein each rule of the one or more rules comprises a respective set of instructions written using a rule-definition language, wherein processing the first output based on the one or more rules comprises, for each rule, executing the respective set of instructions.

10. The method of any of clauses 1-9, wherein transmitting the second output comprises providing the second output for display in a graphical user interface.

11. In some embodiments, a non-transitory computer-readable medium stores instructions that, when executed by one or more processors, cause the one or more processors to perform the steps of causing one or more neural networks to generate a first output based on a first input; identifying one or more rules associated with the first input; processing the first output based on the one or more rules to generate a second output; and transmitting the second output, instead of the first output, as a result of processing the first input.

12. The non-transitory computer-readable medium of clause 11, wherein the steps further comprise identifying one or more pieces of external data associated with the first input; wherein processing the first output based on the one or more rules is further based on the one or more pieces of external data.

13. The non-transitory computer-readable medium of any of clauses 11-12, wherein each rule of the one or more rules comprises one or more respective expressions, wherein processing the first output based on the one or more rules comprises, for each rule, evaluating each expression of the one or more respective expressions.

14. The non-transitory computer-readable medium of any of clauses 11-13, wherein each rule of the one or more rules comprises one or more respective statements, wherein processing the first output based on the one or more rules comprises, for each rule, executing each statement of the one or more respective statements.

15. The non-transitory computer-readable medium of any of clauses 11-14, wherein each rule of the one or more rules specifies one or more respective input parameters, wherein processing the first output based on the one or more rules comprises, for each rule determining one or more portions of the first output that correspond to the one or more respective input parameters; providing the one or more portions of the first output as input to the rule; and evaluating the rule based on the one or more portions of the first output.

16. The non-transitory computer-readable medium of any of clauses 11-15, wherein processing the first output based on the one or more rules further comprises, for each rule determining one or more pieces of external data correspond to the one or more respective input parameters; requesting the one or more pieces of external data from one or more external data sources; providing the one or more pieces of external data as input to the rule; wherein evaluating the rule is further based on the one or more pieces of external data.

17. The non-transitory computer-readable medium of any of clauses 11-16, wherein generating the second output includes generating a natural language expression that indicates to a user one or more results of evaluating the one or more rules.

18. The non-transitory computer-readable medium of any of clauses 11-17, wherein generating the second output includes generating a natural language expression that indicates to a user one or more characteristics of the first output.

19. The non-transitory computer-readable medium of any of clauses 11-18, wherein each rule of the one or more rules comprises a respective set of instructions written using a rule-definition language, wherein processing the first output based on the one or more rules comprises, for each rule, executing the respective set of instructions.

20. In some embodiments, a system comprises a memory that stores instructions, and a processor that is coupled to the memory and, when executing the instructions, is configured to cause one or more neural networks to generate a first output based on a first input; identify one or more rules associated with the first input; process the first output based on the one or more rules to generate a second output; and transmit the second output, instead of the first output, as a result of processing the first input.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing inputs using neural networks, the method comprising:
causing one or more neural networks to generate a first output based on a first input;
identifying one or more rules associated with the first input;
processing the first output based on the one or more rules to generate a second output; and
transmitting the second output, instead of the first output, as a result of processing the first input.

2. The method of claim 1 further comprising:
identifying one or more pieces of external data associated with the first input;
wherein processing the first output based on the one or more rules is further based on the one or more pieces of external data.

3. The method of claim 1 wherein each rule of the one or more rules comprises one or more respective expressions, wherein processing the first output based on the one or more rules comprises, for each rule, evaluating each expression of the one or more respective expressions.

4. The method of claim 1 wherein each rule of the one or more rules comprises one or more respective statements, wherein processing the first output based on the one or more rules comprises, for each rule, executing each statement of the one or more respective statements.

5. The method of claim 1 wherein each rule of the one or more rules specifies one or more respective input parameters, wherein processing the first output based on the one or more rules comprises, for each rule:
determining one or more portions of the first output that correspond to the one or more respective input parameters;
providing the one or more portions of the first output as input to the rule; and
evaluating the rule based on the one or more portions of the first output.

6. The method of claim 5, wherein processing the first output based on the one or more rules further comprises, for each rule:
determining one or more pieces of external data correspond to the one or more respective input parameters;
requesting the one or more pieces of external data from one or more external data sources;
providing the one or more pieces of external data as input to the rule;
wherein evaluating the rule is further based on the one or more pieces of external data.

7. The method of claim 1, wherein generating the second output includes generating a natural language expression that indicates to a user one or more results of evaluating the one or more rules.

8. The method of claim 1, wherein generating the second output includes generating a natural language expression that indicates to a user one or more characteristics of the first output.

9. The method of claim 1, wherein each rule of the one or more rules comprises a respective set of instructions written using a rule-definition language, wherein processing the first output based on the one or more rules comprises, for each rule, executing the respective set of instructions.

10. The method of claim 1, wherein transmitting the second output comprises providing the second output for display in a graphical user interface.

11. A non-transitory computer-readable medium storing instructions that, when executed by one or more processors, cause the one or more processors to perform the steps of:
causing one or more neural networks to generate a first output based on a first input;
identifying one or more rules associated with the first input;
processing the first output based on the one or more rules to generate a second output; and
transmitting the second output, instead of the first output, as a result of processing the first input.

12. The non-transitory computer-readable medium of claim 11, wherein the steps further comprise:
identifying one or more pieces of external data associated with the first input;
wherein processing the first output based on the one or more rules is further based on the one or more pieces of external data.

13. The non-transitory computer-readable medium of claim 11 wherein each rule of the one or more rules comprises one or more respective expressions, wherein processing the first output based on the one or more rules comprises, for each rule, evaluating each expression of the one or more respective expressions.

14. The non-transitory computer-readable medium of claim 11 wherein each rule of the one or more rules comprises one or more respective statements, wherein processing the first output based on the one or more rules comprises, for each rule, executing each statement of the one or more respective statements.

15. The non-transitory computer-readable medium of claim 11 wherein each rule of the one or more rules specifies one or more respective input parameters, wherein processing the first output based on the one or more rules comprises, for each rule:
determining one or more portions of the first output that correspond to the one or more respective input parameters;
providing the one or more portions of the first output as input to the rule; and
evaluating the rule based on the one or more portions of the first output.

16. The one or more non-transitory computer-readable medium of 15, wherein processing the first output based on the one or more rules further comprises, for each rule:
determining one or more pieces of external data correspond to the one or more respective input parameters;
requesting the one or more pieces of external data from one or more external data sources;
providing the one or more pieces of external data as input to the rule;
wherein evaluating the rule is further based on the one or more pieces of external data.

17. The one or more non-transitory computer-readable medium of claim 11, wherein generating the second output includes generating a natural language expression that indicates to a user one or more results of evaluating the one or more rules.

18. The one or more non-transitory computer-readable medium of claim 11, wherein generating the second output includes generating a natural language expression that indicates to a user one or more characteristics of the first output.

19. The one or more non-transitory computer-readable medium of claim 11, wherein each rule of the one or more rules comprises a respective set of instructions written using a rule-definition language, wherein processing the first output based on the one or more rules comprises, for each rule, executing the respective set of instructions.

20. A system comprising:
a memory that stores instructions, and
a processor that is coupled to the memory and, when executing the instructions, is configured to:
cause one or more neural networks to generate a first output based on a first input;
identify one or more rules associated with the first input;
process the first output based on the one or more rules to generate a second output; and
transmit the second output, instead of the first output, as a result of processing the first input.
